(19) United States
(12) Patent Application Publication
(10) Pub. No.: US 2023/0156498 A1
(43) Pub. Date: May 18, 2023

(54) NPDCCH MONITORING RESTRICTIONS FOR NBIOT-NTN SYSTEMS

(71) Applicant: Mavenir Systems, Inc., Richardson, TX (US)

(72) Inventors: Abish Mishra, Bangalore (IN); Atanu Guchhait, Bangalore (IN)

(73) Assignee: Mavenir Systems, Inc., Richardson, TX (US)

(21) Appl. No.: 18/052,714

(22) Filed: Nov. 4, 2022

(30) Foreign Application Priority Data
Nov. 12, 2021 (IN) 202121051977

(51) Int. Cl. H04W 24/08; H04W 56/00

(52) U.S. Cl. CPC H04W 24/08; H04W 56/0045; H04W 84/06

(57) ABSTRACT

A method of optimizing a monitoring time window of NB-IoT physical downlink control channel (NPDCCH) for one of i) narrow-band Internet-of-things (NB-IoT) for non-terrestrial network (NTN) including a satellite and a base station, or ii) 5^{th} Generation New Radio NTN includes: receiving, by a user equipment (UE), a specified signal K_{mac} transmitted by the base station, wherein the specified signal K_{mac} enables the UE to calculate a signal transmission round-trip time (RTT) between the UE and the base station via the satellite; and adjusting, based on the specified signal K_{mac}, NPDCCH monitoring time window when the UE does not need to monitor a downlink (DL) signal transmitted by the base station in response to an uplink (UL) transmission. The signal RTT is equal to the sum of UE's T_{TA} (timing offset between the start of a received downlink subframe and a transmitted uplink subframe) and K_{mac}.

### BACKGROUND OF THE DISCLOSURE

### 1. Field of the Disclosure

The present disclosure relates to 5th Generation (5G) New Radio (NR) non-terrestrial network (NTN) operation, and relates more particularly to monitoring the downlink control signal in Narrow-Band Internet-of-Things (NB-IoT) for NTN.

### 2. Description of the Related Art

NB-IoT physical downlink control channel (NPDCCH) is used to carry Downlink Control Information (DCI). Some examples of information contained in DCI include uplink (UL) grant information and downlink (DL) scheduling information.

In legacy (traditional) terrestrial networks (TNs), an example of which is illustrated in FIG. 1, the propagation delay between UE and enB/gNB (which can be alternatively referenced as a “base station”) is less than 1 msec, as the distance between a user equipment (UE) and eNB would be around 40 KM for the NBIOT case. For NTNs, the propagation delay between UE and eNB would be much larger than 1 msec, as the distance between UE and a GEO satellite and GEO satellite to eNB/gNB would be around 35786 Km. Therefore, in IoT NTN networks, because of the large propagation delays, the duration for which the UE does not need to monitor any DL signal in response to UL transmission needs to be updated compared to traditional terrestrial networks.

Therefore, there is a need to optimize and update the DL monitoring restriction for the UE in IoT NTN networks to improve UE performance.

### SUMMARY OF THE DISCLOSURE

According to an example embodiment of the present disclosure, a method of optimizing the monitoring time window conditions or restrictions of NPDCCH for NBIOT-NTN is provided, which optimization enables UE to reduce power consumption by no longer requiring monitoring of NPDCCH for a dispensable duration.

According to an example embodiment of the present disclosure, the changes that need to be made for NPDCCH monitoring restriction are provided for the case where UE does not need to monitor incoming DL signal which is transmitted by the gNB/eNB in response to UL transmissions.

For an example scenario involving NB-IoT Physical Uplink Shared Channel (NPUSCH) with the same hybrid automatic repeat request (HARQ) process when 2 HARQs are configured, if an NB-IoT UE is configured with higher layer parameter twoHARQ-ProcessesConfig., and if the UE has an NPUSCH transmission ending in subframe n, then at least one of: 1) the UE is not required to receive transmissions in the Type B half-duplex guard periods for FDD; and 2) the UE is not expected to receive an NPDCCH with DCI format N0/N1 for the same HARQ process ID as the NPUSCH transmission in any subframe starting from subframe n+1−n_{TA}^{UE} to subframe n+3+K_{mac}, where n_{TA}^{UE}=ceil(N_{TA,UE-specific}).

For an example scenario relating to monitoring restrictions involving subframe after NPUSCH processing, if the UE is not using higher layer parameter edt-Parameters or if the UE is using higher layer parameter edt-Parameters and 0≤I_{MCS}≤2, (I_{MCS} is the modulation and coding scheme field read from the DCI), then: if the NB-IoT UE has a NPUSCH transmission ending in subframe n, the UE is not required to monitor NPDCCH in any subframe starting from subframe n+1−n_{TA}^{UE} to subframe n+3+K_{mac}, where n_{TA}^{UE}ceil(N_{TA,UE-specific}).

For an example scenario relates to monitoring restrictions involving subframe after NPUSCH carrying Message 3 (Msg3), if the NB-IoT UE has an NPUSCH transmission for Msg3 ending in subframe n′with transport block size TBS_{Msg3}, whereas if maximum transport block size TBS_{Msg3,max} for Msg3 would have been selected the NPUSCH transmission would have ended in subframe n, the UE is not required to monitor NPDCCH in any subframe starting from subframe n′+1−n_{TA}^{UE} to subframe n+3+K_{mac}, where n_{TA}^{UE}=ceil(N_{TA,UE-specific}).

For an example scenario relating to Narrowband Physical Random-Access Channel (NPRACH) for scheduling request (SR) involved in a long NPRACH transmission, for an NB-IoT UE configured with higher layer parameter sr-WithoutHARQ-ACK-Config, if the transmission of a narrowband random access preamble for SR ends on subframe n, then: in case of frame structure type 1 with NPRACH format 0 and 1 when the number of NPRACH repetitions is greater than or equal to 64, or NPRACH format 2 when the number of NPRACH repetitions is greater than or equal to 16, the UE is not required to monitor NPDCCH UE-specific search space from subframe n−n_{TA}^{UE} to subframe n+40+K_{mac}, where n_{TA}^{UE}=ceil(N_{TA,UE-specific}).

For an example scenario relating to Narrowband Physical Random-Access Channel (NPRACH) for scheduling request (SR) involved in a short NPRACH transmission, for an NB-IoT UE configured with higher layer parameter sr-WithoutHARQ-ACK-Config, unless the transmission of a narrowband random access preamble for SR ends on subframe n, the UE is not required to monitor NPDCCH UE-specific search space from subframe n−n_{TA}^{UE} to subframe n+3+K_{mac}, where n_{TA}^{UE}=ceil(N_{TA,UE-specific}).

### BRIEF DESCRIPTION OF THE FIGURES

FIG. 1 is a diagram illustrating an example propagation delay between UE and eNB/gNB in a terrestrial network (TN).

FIG. 2 is a diagram illustrating an example propagation delay between UE and eNB/gNB in NTN.

### DETAILED DESCRIPTION

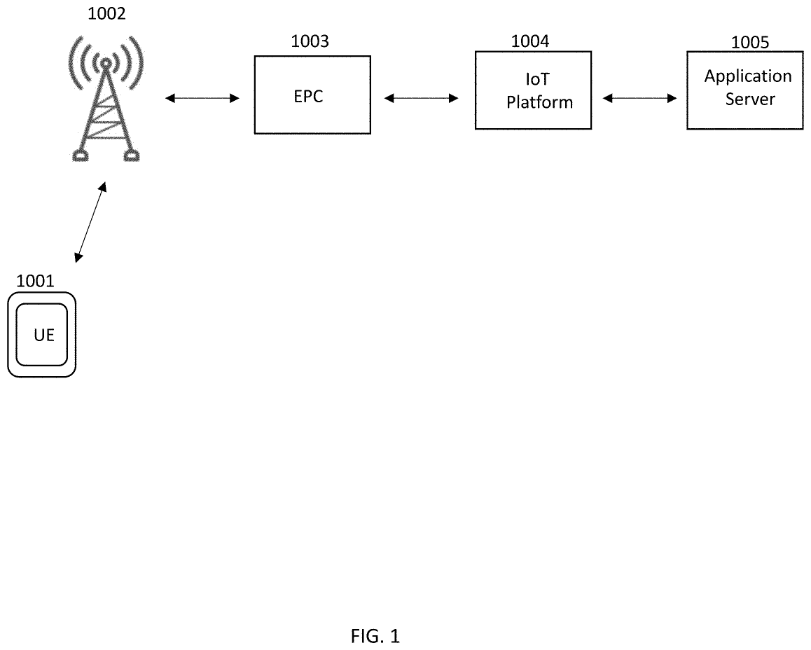

FIG. 1 is a diagram illustrating an example legacy terrestrial network (TN), which includes UE 1001, eNB/gNB 1002, evolved packet core (EPC) 1003, internet of things (IoT) platform 1004, and application server 1005. In the example legacy TN shown in FIG. 1, the propagation delay between UE 1001 and eNB/gNB 1002 is typically less than 1 msec (as the distance between UE and eNB would be around 40 KM for the typical NBIOT scenario).

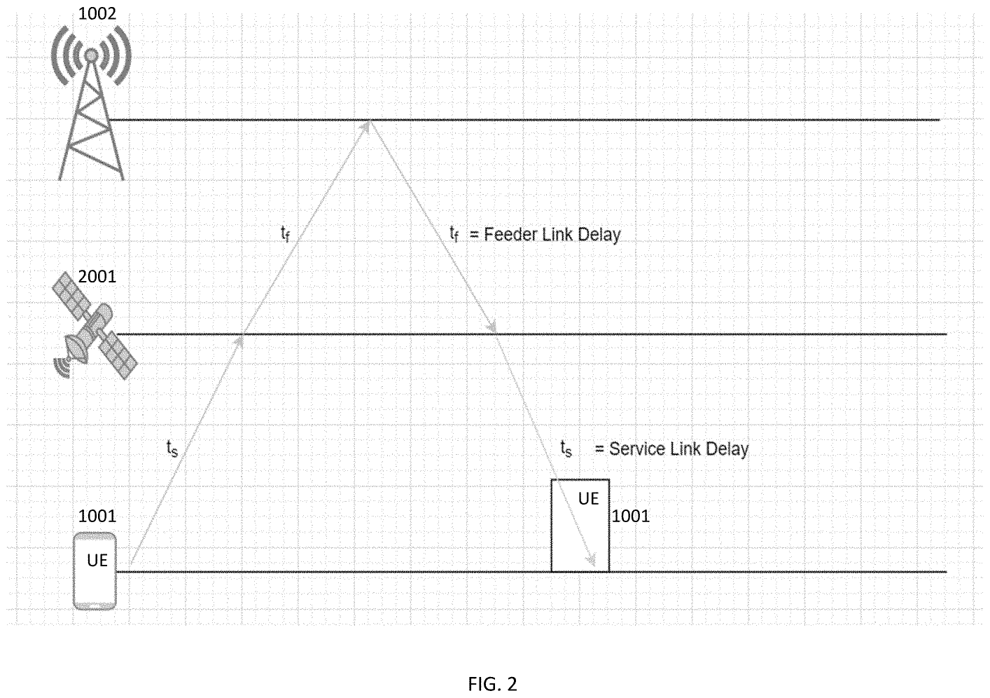

FIG. 2 illustrates an example propagation delay between UE and eNB/gNB in NTN, which NTN includes a GEO satellite 2001 and an eNB/gNB 1002. For the NTN shown in FIG. 2, the propagation delay between UE 1001 and eNB/gNB 1002 would be much larger than 1 msec, as the total distance starting from UE 1001 to a GEO satellite 2001, then to eNB/gNB 1002 would be around 35786 Km, for example. Considering the long propagation delays in NTN, the existing NPDCCH monitoring restrictions need to be optimized and updated where UE is not required to monitor NPDCCH.

In connection with FIG. 2, some parameters relevant to the NTN delay will be explained here. Feeder-link delay, denoted as t_{f}, refers to one-way over-the-air (OTA) delay between the eNB/gNB 1002 and the satellite 2001. Service-link delay, denoted as tₛ, refers to one-way OTA delay between the satellite 2001 and UE 1001. Timing advance, TA, is a UE offset between the start of a received downlink subframe and a transmitted uplink subframe, which offset at the UE is necessary to ensure that downlink and uplink subframes are synchronized with the eNB. T_{TA} denotes the time length of the TA. K_{offset}, which is in the unit of subframes, refers to an integer which is signaled (e.g., by the eNB/gNB) to the UE and is used by the UE to delay transmission time of a UL transmission which is triggered by a DL reception at the UE so that the causality of the UE operation is guaranteed. K_{offset} should always satisfy the condition K_{offset}≥T_{TA}/1 ms. Kₘₐₓ is an integer which is signaled (e.g., by the eNB/gNB) to the UE and is used by the UE to calculate RTT between the UE and the eNB/gNB.

In the following sections, the proposed changes for optimizing the NPDCCH monitoring restrictions are discussed for various scenarios. UE-specific TA will be used by UE in connected mode before UL transmission. n_{TA}^{UE} is the UE-specific TA in the unit of subframes, and n_{TA}^{UE}=ceil(N_{TA,UE-specific}) in msec (any floating value will be converted to upper integer value, e.g., ceil(3.23)=4). The estimate of UE to eNB/gNB (base station) round trip time (RTT) is equal to the sum of UE's T_{TA} and K_{mac}, where UE's T_{TA} is represented by the following formula:

T_{TA}=(N_{TA,UE-specific}+N_{TA,common}+N_{TA,offset})×Tₛ

In the above formula, the various variables are defined as follows:
a) N_{TA} is timing offset between uplink and downlink radio frames at the UE, expressed in units of Tₛ. N_{TA} works in the same way as legacy terrestrial networks. It is part of closed-loop uplink timing correction procedure. The amount of timing advance is being estimated by the eNB and the value is being communicated to UE in timing advance command.
b) N_{TA,UE-specific} is UE-self-estimated TA to pre-compensate for the service link delay between the UE and the satellite. It is computed by the UE based on satellite-ephemeris-related higher-layers parameters if configured, otherwise N_{TA,UE-specific}=0.
c) N_{TA,common} is network-controlled (or network-specified) common TA, and may include any timing offset considered necessary by the network (e.g., feeder link delay). It is derived from the higher-layer parameters TACommon, TACommonDrift, and TACommonDriftVariation if configured, otherwise N_{TA,common}=0. These parameters are given to the UE in SIB31-NB.
d) N_{TA, offset} is Fixed timing advance offset, expressed in units of Tₛ. For frame structure type 1, N_{TA,offset}=0.
e) Tₛ is basic unit of time expressed in millisecond (msec). Therefore, the granularity of T_{TA} is 1 Tₛ, i.e., 1 msec.

In the present disclosure, several example optimization changes (relative to existing configuration restrictions in Terrestrial Network) are provided, e.g., to 3GPP TS36.213 version 16.6, to accommodate the impact of UE-eNB RTT.

### EXAMPLE SCENARIO A

This example scenario involves NB-IoT Physical Uplink Shared Channel (NPUSCH) with the same hybrid automatic repeat request (HARQ) process when 2 HARQs are configured. As a point of reference, the existing configuration restrictions (e.g., 3GPP TS36.213 version 16.6) in a Terrestrial Network (TN) provide that, if an NB-IoT UE is configured with higher layer parameter twoHARQ-ProcessesConfig., and if the UE has an NPUSCH transmission ending in subframe n, then: 1) the UE is not required to receive transmissions in the Type B half-duplex guard periods for frequency division duplex (FDD); and 2) the UE is not expected to receive an NB-IoT Physical Downlink Control Channel (NPDCCH) with downlink control information (DCI) format N0/N1 for the same HARQ process ID as the NPUSCH transmission in any subframe starting from subframe n+1 to subframe n+3.

In contrast, for NTN, the UE DL Acknowledgement (ACK)/Negative Acknowledgement (NACK) monitoring restrictions are modified for this example scenario. The HARQ-ACK timing in response to NPUSCH transmission is n+4+K_{mac}. The DL subframe n+3+K_{mac} corresponds to the subframe immediately before HARQ-ACK. Also, it should be noted that the DL subframe n+1−n_{TA}^{UE} starts immediately after UL subframe n. Therefore, the below-described changes need to be applied to the existing specifications, e.g., to 3GPP TS36.213 version 16.6, to properly accommodate the RTT between the UE and eNB. If an NB-IoT UE is configured with higher layer parameter twoHARQ-ProcessesConfig., and if the UE has an NPUSCH transmission ending in subframe n, then at least one of: 1) the UE is not required to receive transmissions in the Type B half-duplex guard periods for FDD; and 2) the UE is not expected to receive an NPDCCH with DCI format N0/N1 for the same HARQ process ID as the NPUSCH transmission in any subframe starting from subframe n+1−n_{TA}^{UE} to subframe n+3+K_{mac}, where n_{TA}^{UE}=ceil(N_{TA,UE-specific}).

### EXAMPLE SCENARIO B

This example scenario relates to monitoring restrictions involving subframe after NPUSCH processing. As a point of reference, the existing configuration restrictions (e.g., 3GPP TS36.213 version 16.6) in a Terrestrial Network (TN) provide that, if the UE is not using higher layer parameter edt-Parameters or if the UE is using higher layer parameter edt-Parameters and 0≤I_{MCS}≤2 , (I_{MCS} is the modulation and coding scheme field read from the DCI), then: if the NB-IoT UE has a NPUSCH transmission ending in subframe n , the UE is not required to monitor NPDCCH in any subframe starting from subframe n+1 to subframe n+3.

In contrast, for NTN, the UE DL monitoring restrictions are modified for this example scenario, i.e., the below-described changes need to be applied to the existing specifications, e.g., to 3GPP TS36.213 version 16.6, to properly accommodate the RTT between the UE and eNB. If the UE is not using higher layer parameter edt-Parameters or if the UE is using higher layer parameter edt-Parameters and 0≤I_{MCS}≤2, (I_{MCS} is the modulation and coding scheme field read from the DCI), then: if the NB-IoT UE has a NPUSCH transmission ending in subframe n , the UE is not required to monitor NPDCCH in any subframe starting from subframe n+1−n_{TA}^{UE} to subframe n+3+K_{mac}, where n_{TA}^{UE}=ceil(N_{TA,UE-specific}).

### EXAMPLE SCENARIO C

This example scenario relates to monitoring restrictions involving subframe after NPUSCH carrying Message 3 (Msg3). As a point of reference, the existing configuration restrictions (e.g., 3GPP TS36.213 version 16.6) in a Terrestrial Network (TN) provide that, if the NB-IoT UE has an NPUSCH transmission for Msg3 ending in subframe n′with transport block size TBS_{Msg3}, whereas if maximum transport block size TBS_{Msg3,max} for Msg3 would have been selected the NPUSCH transmission would have ended in subframe n, the UE is not required to monitor NPDCCH in any subframe starting from subframe n′+1 to subframe n+3.

In contrast, for NTN, the UE DL monitoring restrictions are modified for this example scenario, i.e., the below-described changes need to be applied to the existing specifications, e.g., to 3GPP TS36.213 version 16.6, to properly accommodate the RTT between the UE and eNB. If the NB-IoT UE has an NPUSCH transmission for Msg3 ending in subframe n′with transport block size TBS_{Msg3}, whereas if maximum transport block size TBS_{Msg3,max} for Msg3 would have been selected the NPUSCH transmission would have ended in subframe n, the UE is not required to monitor NPDCCH in any subframe starting from subframe n′+1−n_{TA}^{UE} to subframe n+3+K_{mac}, where n_{TA}^{UE}=ceil(N_{TA,UE-specific}).

### EXAMPLE SCENARIO D

This example scenario relates to Narrowband Physical Random-Access Channel (NPRACH) for scheduling request (SR) involved in long NPRACH transmission. As a point of reference, the existing configuration restrictions (e.g., 3GPP TS36.213 version 16.6) in a Terrestrial Network (TN) provide that, for an NB-IoT UE configured with higher layer parameter sr-WithoutHARQ-ACK-Config, if the transmission of a narrowband random access preamble for SR ends on subframe n, then: in case of frame structure type 1 with NPRACH format 0 and 1 when the number of NPRACH repetitions is greater than or equal to 64, or NPRACH format 2 when the number of NPRACH repetitions is greater than or equal to 16, the UE is not required to monitor NPDCCH UE-specific search space from subframe n to subframe n+40.

In contrast, for NTN, the UE DL monitoring restrictions are modified for this example scenario, i.e., the below-described changes need to be applied to the existing specifications, e.g., to 3GPP TS36.213 version 16.6, to properly accommodate the RTT between the UE and eNB. For an NB-IoT UE configured with higher layer parameter sr-WithoutHARQ-ACK-Config, if the transmission of a narrowband random access preamble for SR ends on subframe n, then: in case of frame structure type 1 with NPRACH format 0 and 1 when the number of NPRACH repetitions is greater than or equal to 64, or NPRACH format 2 when the number of NPRACH repetitions is greater than or equal to 16, the UE is not required to monitor NPDCCH UE-specific search space from subframe n−n_{TA}^{UE} to subframe n+40+K_{mac}, where n_{TA}^{UE}=ceil(N_{TA,UE-specific}).

### EXAMPLE SCENARIO E

This example scenario relates to Narrowband Physical Random-Access Channel (NPRACH) for scheduling request (SR) involved in short NPRACH transmission. As a point of reference, the existing configuration restrictions (e.g., 3GPP TS36.213 version 16.6) in a Terrestrial Network (TN) provide that, for an NB-IoT UE configured with higher layer parameter sr-WithoutHARQ-ACK-Config, unless the transmission of a narrowband random access preamble for SR ends on subframe n, the UE is not required to monitor NPDCCH UE-specific search space from subframe n to subframe n+3.

In contrast, for NTN, the UE DL monitoring restrictions are modified for this example scenario, i.e., the below-described changes need to be applied to the existing specifications, e.g., to 3GPP TS36.213 version 16.6, to properly accommodate the RTT between the UE and eNB. For an NB-IoT UE configured with higher layer parameter sr-WithoutHARQ-ACK-Config, unless the transmission of a narrowband random access preamble for SR ends on subframe n, the UE is not required to monitor NPDCCH UE-specific search space from subframe n−n_{TA}^{UE} to subframe n+3+K_{mac}, where n_{TA}^{UE}=ceil(N_{TA,UE-specific}).

According to the example embodiments of the present disclosure, impact of K_{mac} timing is taken into consideration for optimizing the monitoring window for DL reception at UE. The disclosed example embodiments of system optimization will help UEs reduce power consumption as UEs will not be required to monitor for DL signal for a longer duration.

Although the example embodiments of the present disclosure have been described in the context of NB-IoT for NTN operation, the present disclosure is equally applicable to 5G NR NTN operation, e.g., LTE Machine Type Communication (LTE-M) technology, and [symbol] .

### ABBREVIATIONS

3GPP: 3rd Generation Partnership Project
5GC: 5G Core
eNB: evolved Node B
FDD: frequency division duplex
gNB: next generation Node B
HARQ: Hybrid automatic repeat request
LTE: Long Term Evolution
MIB: Master Information Block
NPDCCH: NB-IoT Physical Downlink Control Channel
NPUSCH: NB-IoT Physical Uplink Shared Channel
NTN—Non Terrestrial Network
NR: 5G New Radio
PDCP: Packet Data Convergence Protocol
PHY: Physical layer
PNF: Physical Network Function
PRACH: Physical Random Access Channel
RAN: Radio Access Network
RAT: Radio Access Technology
RF: Radio Frequency
RLC: Radio Link Control
RRC: Radio Resource Control
RRM: Radio Resource Management
SIB: System Information Block
UE: User Equipment

1. A method of optimizing a monitoring time window of NB-IoT physical downlink control channel (NPDCCH) for one of i) narrow-band Internet-of-things (NB-IoT) for non-terrestrial network (NTN) including a satellite and a base station, or ii) 5^{th} Generation New Radio NTN, the method comprising:
receiving, by a user equipment (UE), a specified signal transmitted by the base station, wherein the specified signal enables the UE to calculate a signal transmission round-trip time between the UE and the base station via the satellite; and
adjusting, based on the specified signal, NPDCCH monitoring time window when the UE does not need to monitor a downlink (DL) signal transmitted by the base station in response to an uplink (UL) transmission.

2. The method according to claim 1, wherein the specified signal is K_{mac} representing an integer.

3. The method according to claim 2, wherein:
the signal transmission round-trip time between the UE and the base station via the satellite is equal to the sum of UE's T_{TA} and K_{mac};
UE's T_{TA} is defined as a length of time of timing advance, TA, which TA is a UE offset between the start of a received downlink subframe and a transmitted uplink subframe, and T_{TA} is represented by the following formula:
T_{TA}=(N_{TA}+N_{TA,UE-specific}+N_{TA,common}+N_{TA,offset})×Tₛ
Tₛ is a unit of time expressed in millisecond (msec);
N_{TA} is timing offset between uplink and downlink radio frames at the UE, expressed in units of Tₛ;
N_{TA,UE-specific} is UE-self-estimated TA to pre-compensate for the service link delay between the satellite and the UE;
N_{TA,common} is network-specified TA; and
N_{TA,offset} is a fixed timing advance offset, expressed in units of Tₛ.

4. The method according to claim 3, wherein the method is for optimizing the monitoring time window of NPDCCH for NB-IoT NTN.

5. The method of claim 3, further comprising:
receiving, by the UE, a second specified signal K_{offse} transmitted by the base station, wherein K_{offset} represents units of subframes, and wherein K_{offset} is used by the UE to delay transmission time of a UL transmission which is triggered by a DL reception.

6. The method according to claim 3, wherein:
in the case NB-IoT Physical Uplink Shared Channel (NPUSCH) with the same hybrid automatic repeat request (HARQ) process when 2 HARQs are configured, if an NB-IoT UE is configured with parameter twoHARQ-ProcessesConfig., and if the UE has an NPUSCH transmission ending in subframe n, then at least one of: 1) the UE is not required to receive transmissions in the Type B half-duplex guard periods for FDD; and 2) the UE is not expected to receive an NPDCCH with DCI format N0/N1 for the same HARQ process ID as the NPUSCH transmission in any subframe starting from subframe n+1−n_{TA}^{UE} to subframe n+3+K_{mac}, wherein n_{TA}^{UE}=ceil(N_{TA,UE-specific}).

7. The method of claim 3, wherein:
in the case of monitoring restrictions involving subframe after NB-IoT Physical Uplink Shared Channel (NPUSCH) processing, if one of i) the UE is not using parameter edt-Parameters or ii) the UE is using parameter edt-Parameters and 0≤I_{MCS}≤2, wherein I_{MCS} is a modulation and coding scheme field, then: if the UE has an NPUSCH transmission ending in subframe n, the UE is not required to monitor NPDCCH in any subframe starting from subframe n+1−n_{TA}^{UE} to subframe n+3+K_{mac}, wherein n_{TA}^{UE}=ceil(N_{TA,UE-specific}).

8. The method of claim 3, wherein:
in the case of monitoring restrictions involving subframe after NB-IoT Physical Uplink Shared Channel (NPUSCH) carrying Message 3 (Msg3), if the UE has an NPUSCH transmission for Msg3 ending in subframe n′ with transport block size TBS_{Msg3}, whereas if maximum transport block size TBS_{Msg3,max} for Msg3 would have been selected the NPUSCH transmission would have ended in subframe n, the UE is not required to monitor NPDCCH in any subframe starting from subframe n′+1−n_{TA}^{UE} to subframe n+3+K_{mac}, wherein n_{TA}^{UE}=ceil(N_{TA,UE-specific}).

9. The method of claim 3, wherein:
in the case of Narrowband Physical Random-Access Channel (NPRACH) for scheduling request (SR) involved in a long NPRACH transmission, if the UE is configured with parameter sr-WithoutHARQ-ACK-Config, and if the transmission of a narrowband random access preamble for SR ends on subframe n, then: in case of frame structure type 1 with NPRACH format 0 and 1 when the number of NPRACH repetitions is greater than or equal to 64, or NPRACH format 2 when the number of NPRACH repetitions is greater than or equal to 16, the UE is not required to monitor NPDCCH UE-specific search space from subframe n−n_{TA}^{UE} to subframe n+40+K_{mac}, wherein n_{TA}^{UE}=ceil(N_{TA,UE-specific}).

10. The method of claim 3, wherein:
in the case of Narrowband Physical Random-Access Channel (NPRACH) for scheduling request (SR) involved in a short NPRACH transmission, if the UE is configured with parameter sr-WithoutHARQ-ACK-Config, unless the transmission of a narrowband random access preamble for SR ends on subframe n, the UE is not required to monitor NPDCCH UE-specific search space from subframe n−n_{TA}^{UE} to subframe n+3+K_{mac}, wherein n_{TA}^{UE}=ceil(N_{TA,UE-specific}).

11. The method according to claim 4, wherein:
in the case NB-IoT Physical Uplink Shared Channel (NPUSCH) with the same hybrid automatic repeat request (HARQ) process when 2 HARQs are configured, if an NB-IoT UE is configured with parameter twoHARQ-ProcessesConfig., and if the UE has an NPUSCH transmission ending in subframe n, then at least one of: 1) the UE is not required to receive transmissions in the Type B half-duplex guard periods for FDD; and 2) the UE is not expected to receive an NPDCCH with DCI format N0/N1 for the same HARQ process ID as the NPUSCH transmission in any subframe starting from subframe n+1−n_{TA}^{UE} to subframe n+3+K_{mac}, wherein n_{TA}^{UE}=ceil(N_{TA,UE-specific}).

12. The method of claim 4, wherein:
in the case of monitoring restrictions involving subframe after NB-IoT Physical Uplink Shared Channel (NPUSCH) processing, if one of i) the UE is not using parameter edt-Parameters or ii) the UE is using parameter edt-Parameters and 0≤I_{MCS}≤2, wherein I_{MCS} is a modulation and coding scheme field, then: if the UE has an NPUSCH transmission ending in subframe n , the UE is not required to monitor NPDCCH in any subframe starting from subframe n+1−n_{TA}^{UE} to subframe n+3+K_{mac}, wherein n_{TA}^{UE}=ceil(N_{TA,UE-specific}).

13. The method of claim 4, wherein:
in the case of monitoring restrictions involving subframe after NB-IoT Physical Uplink Shared Channel (NPUSCH) carrying Message 3 (Msg3), if the UE has an NPUSCH transmission for Msg3 ending in subframe n′ with transport block size TBS_{Msg3}, whereas if maximum transport block size TBS_{Msg3,max} for Msg3 would have been selected the NPUSCH transmission would have ended in subframe n, the UE is not required to monitor NPDCCH in any subframe starting from subframe n′+1−n_{TA}^{UE} to subframe n+3+K_{mac}, wherein n_{TA}^{UE}=ceil(N_{TA,UE-specific}).

14. The method of claim 4, wherein:
in the case of Narrowband Physical Random-Access Channel (NPRACH) for scheduling request (SR) involved in a long NPRACH transmission, if the UE is configured with parameter sr-WithoutHARQ-ACK-Config, and if the transmission of a narrowband random access preamble for SR ends on subframe n, then: in case of frame structure type 1 with NPRACH format 0 and 1 when the number of NPRACH repetitions is greater than or equal to 64, or NPRACH format 2 when the number of NPRACH repetitions is greater than or equal to 16, the UE is not required to monitor NPDCCH UE-specific search space from subframe n−n_{TA}^{UE} to subframe n+40+K wherein n_{TA}^{UE}=ceil(N_{TA,UE-specific}).

15. The method of claim 4, wherein:
in the case of Narrowband Physical Random-Access Channel (NPRACH) for scheduling request (SR) involved in a short NPRACH transmission, if the UE is configured with parameter sr-WithoutHARQ-ACK-Config, unless the transmission of a narrowband random access preamble for SR ends on subframe n, the UE is not required to monitor NPDCCH UE-specific search space from subframe n−n_{TA}^{UE} to subframe n+3+K_{mac}, wherein n_{TA}^{UE}=ceil(N_{TA,UE-specific}).

16. The method according to claim 5, wherein:
in the case NB-IoT Physical Uplink Shared Channel (NPUSCH) with the same hybrid automatic repeat request (HARQ) process when 2 HARQs are configured, if an NB-IoT UE is configured with parameter twoHARQ-ProcessesConfig., and if the UE has an NPUSCH transmission ending in subframe n, then at least one of: 1) the UE is not required to receive transmissions in the Type B half-duplex guard periods for FDD; and 2) the UE is not expected to receive an NPDCCH with DCI format N0/N1 for the same HARQ process ID as the NPUSCH transmission in any subframe starting from subframe n+1−n_{TA}^{UE} to subframe n+3+K_{mac}, wherein n_{TA}^{UE}=ceil(N_{TA,UE-specific}).

17. The method of claim 5, wherein:
in the case of monitoring restrictions involving subframe after NB-IoT Physical Uplink Shared Channel (NPUSCH) processing, if one of i) the UE is not using parameter edt-Parameters or ii) the UE is using parameter edt-Parameters and 0≤I_{MCS}≤2, wherein I_{MCS} is a modulation and coding scheme field, then: if the UE has an NPUSCH transmission ending in subframe n , the UE is not required to monitor NPDCCH in any subframe starting from subframe n+1−n_{TA}^{UE} to subframe n+3+K_{mac}, wherein n_{TA}^{UE}=ceil(N_{TA,UE-specific}).

18. The method of claim 5, wherein:
in the case of monitoring restrictions involving subframe after NB-IoT Physical Uplink Shared Channel (NPUSCH) carrying Message 3 (Msg3), if the UE has an NPUSCH transmission for Msg3 ending in subframe n′ with transport block size TBS_{Msg3}, whereas if maximum transport block size TBS_{Msg3, max} for Msg3 would have been selected the NPUSCH transmission would have ended in subframe n, the UE is not required to monitor NPDCCH in any subframe starting from subframe n′+1−n_{TA}^{UE} to subframe n+3+K_{mac}, wherein n_{TA}^{UE}=ceil(N_{TA,UE-specific}).

19. The method of claim 5, wherein:
in the case of Narrowband Physical Random-Access Channel (NPRACH) for scheduling request (SR) involved in a long NPRACH transmission, if the UE is configured with parameter sr-WithoutHARQ-ACK-Config, and if the transmission of a narrowband random access preamble for SR ends on subframe n, then: in case of frame structure type 1 with NPRACH format 0 and 1 when the number of NPRACH repetitions is greater than or equal to 64, or NPRACH format 2 when the number of NPRACH repetitions is greater than or equal to 16, the UE is not required to monitor NPDCCH UE-specific search space from subframe n−n_{TA}^{UE} to subframe n+40+K_{mac}, wherein n_{TA}^{UE}=ceil(N_{TA,UE-specific}).

20. The method of claim 5, wherein:
in the case of Narrowband Physical Random-Access Channel (NPRACH) for scheduling request (SR) involved in a short NPRACH transmission, if the UE is configured with parameter sr-WithoutHARQ-ACK-Config, unless the transmission of a narrowband random access preamble for SR ends on subframe n, the UE is not required to monitor NPDCCH UE-specific search space from subframe n−n_{TA}^{UE} to subframe n+3 +K_{mac}, wherein n_{TA}^{UE}=ceil(N_{TA,UE-specific}).
